(19) United States
(12) Patent Application Publication
(10) Pub. No.: US 2005/0090295 A1
(43) Pub. Date: Apr. 28, 2005

(54) Communication headset with signal processing capability

(75) Inventors: Kamal Ali, Oakville (CA); Sukhminder Binapal, Burlington (CA); Atin Patel, Mississauga (CA); Gora Ganguli, Burlington (CA); Brad Marshall, Kitchener (CA)

Correspondence Address: JOSEPH M. SAUER;JONES DAY REAVIS & POGUE, NORTH POINT, 901 LAKESIDE AVENUE, CLEVELAND, OH, 44114, US

(73) Assignee: Gennum Corporation

(21) Appl. No.: 10/961,762

(22) Filed: Oct. 8, 2004

Related U.S. Application Data
(60) Provisional application No. 60/510,878, filed on Oct. 14, 2003.

(51) Int. Cl. H04M 1/00; H04M 9/00

(52) U.S. Cl. 455/575.2; 455/569.1

(57) ABSTRACT

In accordance with the teachings described herein, a communication headset with signal processing capabilities is provided. A radio communications circuitry may be included to communicate wirelessly with a communications device. A speaker may be included for directing acoustical signals into the ear canal of a headset user. A microphone may be included for receiving acoustical signals. A digital signal processor may be included for processing acoustical signals, the digital signal processor being operable in a first mode, such as a communication mode, and in a second mode, such as a hearing instrument mode.

### CROSS-REFERENCE TO RELATED APPLICATION

This application claims priority from and is related to the following prior application: “Communication Headset with Signal Processing Capability,” U.S. Provisional Application No. 60/510,878, filed Oct. 14, 2003. This prior application, including the entirety of the written description and drawing figures, is hereby incorporated into the present application by reference.

### FIELD

The technology described in this patent document relates generally to the field of communication headsets. More particularly, the patent document describes a multi-microphone, electronically-adjustable voice-focus, boomless headset, which is particularly well-suited for use as a wireless headset for communicating with a cellular telephone. In addition, the headset can be used as a digital hearing aid.

### BACKGROUND

Wireless headsets are used to wirelessly connect to a user's cell phone thereby enabling hands-free use of a cell-phone. The wireless link can be established using a variety of technologies, such as the Bluetooth short range wireless technology. In high ambient noise environments, which may include unwanted nearby voices as well as other types of environmental noise, the headset, through its microphone, may pick up the user's voice and the ambient noise, and transmit both to the receiving party. This often makes conversations difficult to carry on between two parties.

### SUMMARY

In accordance with the teachings described herein, a communication headset with signal processing capabilities is provided. A radio communications circuitry may be included to communicate wirelessly with a mobile device. A speaker may be included for directing acoustical signals into the ear canal of a headset user. A microphone may be included for receiving acoustical signals. A digital signal processor may be included for processing acoustical signals, the digital signal processor being operable in a first mode, such as a communication mode, and in a second mode, such as a hearing instrument mode.

A first example embodiment provides a dual-mode wireless headset for a communication device having the following characteristics: a radio communications circuitry that is operable to communicate wirelessly with the communication device; a speaker for directing acoustical signals into the ear canal of a headset user; a microphone for receiving acoustical signals; and a digital signal processor for processing acoustical signals, the digital signal processor being operable in a first mode and a second mode. When in the first mode, the digital signal processor is operable to process an acoustical signal received by the microphone to control the directionality of the microphone such that the voice of the headset user is prominent in the acoustical signal. When in the second mode, the digital signal processor is operable to process the acoustical signal received by the microphone to control the directionality of the microphone such that sounds other than the voice of the headset user are prominent in the acoustical signal. When in the first mode, the digital signal processor is further operable to transmit the processed acoustical signal to the communication device via the radio communications circuitry.

A second example embodiment provides a dual-mode wireless headset for a communication device having the following characteristics: a radio communications circuitry that is operable to communicate wirelessly with the communication device; a speaker for directing acoustical signals into the ear canal of a headset user; a microphone for receiving acoustical signals; and a digital signal processor for processing acoustical signals, the digital signal processor being operable in a communication mode and a hearing instrument mode. When in the communication mode, the digital signal processor is operable to communicate wirelessly with the communication device to transmit acoustical signals received by the microphone to the communication device and to transmit acoustical signals received from the communication device into the ear canal of the headset user via the speaker. When in the hearing instrument mode, the digital signal processor is operable to process acoustical signals received by the microphone to compensate for a hearing impairment of the headset user and to transmit the processed acoustical signals into the ear canal of the headset user via the speaker. The digital signal processor is further operable to process acoustical signals to be transmitted into the ear canal of the headset user to reduce an occlusion effect perceived by the headset user.

A third example embodiment provides a dual-mode wireless headset having the following characteristics: radio communications circuitry that is operable to communicate wirelessly with an external device; a speaker for directing acoustical signals into the ear canal of a headset user; a microphone for receiving acoustical signals; and a digital signal processor for processing acoustical signals, the digital signal processor being operable in a first mode and a second mode. When in the first mode, the digital signal processor is operable to wirelessly receive a first acoustical signal from the external device via the radio communications circuitry, process the first acoustical signal to alter the audio characteristics of the first acoustical signal using pre-programmed amplitude and bandwidth settings and transmit the processed first acoustical signal into the ear canal of the headset user via the speaker. When in the second mode, the digital signal processor is operable to receive a second acoustical signal from the microphone, process the second acoustical signal to compensate for a hearing impairment of the headset user and transmit the processed second acoustical signal into the ear canal of the headset user via the speaker. The digital signal processor is further operable to wirelessly receive an equalizer setting via the radio communications circuitry and use the equalizer setting to program the amplitude and bandwidth settings.

### BRIEF DESCRIPTION OF THE DRAWINGS

FIG. 1 is a block diagram of an example communications headset having signal processing capabilities.

FIG. 2 is a block diagram of an example digital signal processor.

FIGS. 3A-3C are a series of directional response plots that may be generated using the digital signal processor described herein.

FIG. 4 is a block diagram of an example communication headset having signal processing capabilities in which a pair of signal processors are provided for enhancing the performance of the headset.

FIG. 5 is a block diagram of another example digital signal processor.

FIG. 6 is a block diagram of an example communication headset having signal processing capabilities and a pair of signal processors.

FIGS. 7A and 7B are a block diagram of an example digital hearing instrument system.

FIGS. 8 and 9 are block diagrams of an example communication headset having signal processing capabilities and also providing wired and wireless audio processing.

### DETAILED DESCRIPTION

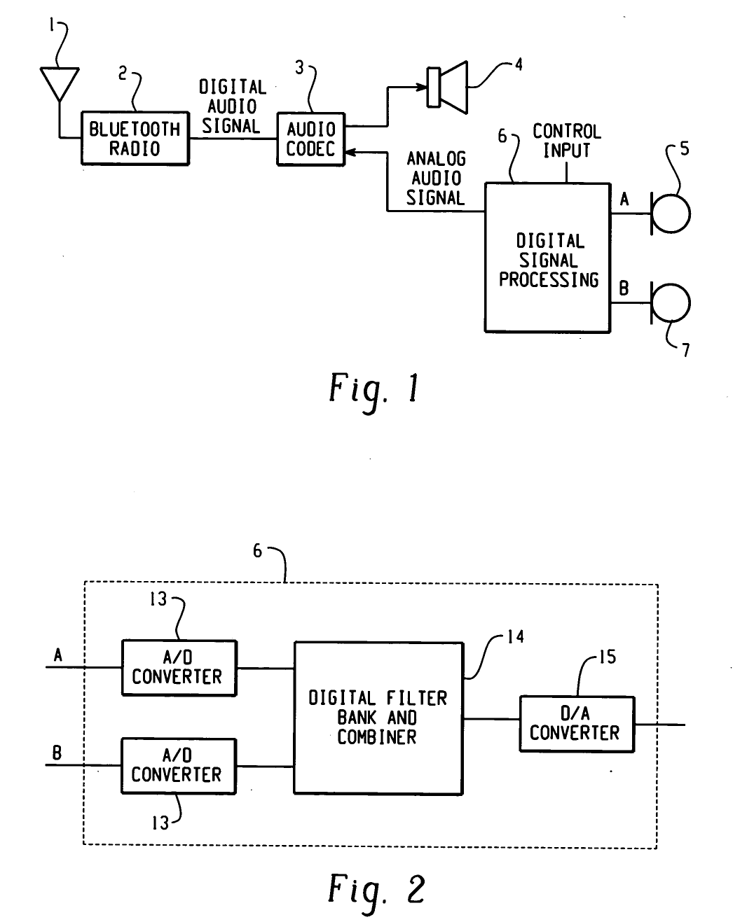

FIG. 1 is a block diagram of an example communications headset having signal processing capabilities. This example wireless headset includes a digital signal processor 6 in the microphone path. The illustrated wireless headset may, for example, be used to establish a wireless link (e.g., a Bluetooth link) with a communication device, such as a cell phone, in order to send and receive audio signals. Other types of wireless links could also be utilized, and the device may be configured to communicate with a variety of different electronic devices, such as radios, MP3 players, CD players, portable game machines, etc. The wireless headset includes an antenna 1, a radio 2 (e.g., a Bluetooth radio), an audio codec 3, and a speaker 4. In addition, the wireless headset further includes the digital signal processor 6 and a pair of microphones 5, 7.

Incoming audio signals may be transmitted from the communication device over the wireless link to the antenna 1. The received audio signal is then converted from a radio frequency (RF) signal to a digital signal by the radio 2. The digital audio output from the radio 2 is transformed into an analog audio signal by the audio CODEC 3. The analog audio signal from the audio CODEC 3 is then converted into an acoustical signal by the speaker 4 and the acoustical signal is directed into the ear of the wireless headset user. In other examples, communications between the radio 2 and the digital signal processor 6 may be in the digital domain. For instance, in one example the audio CODEC 3 or some other type of D/A converter may be embedded within the radio circuitry 2.

Outgoing acoustical signals (e.g., audio spoken by the headset user) are received by the microphones 5, 7 and converted into audio signals. The audio signals from the microphones 5, 7 are routed to inputs A and B of the digital signal processor 6, respectively.

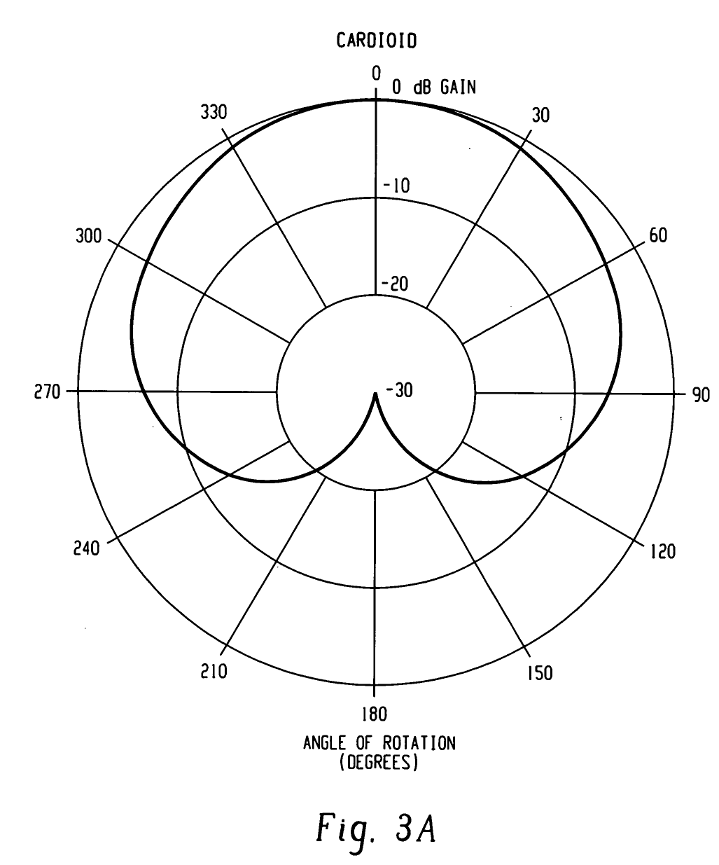

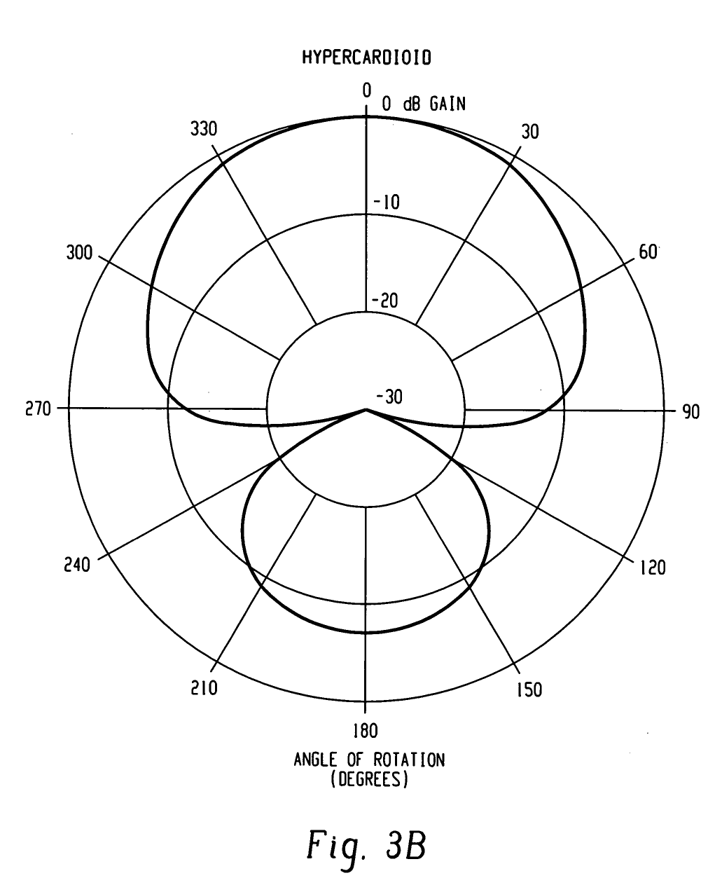

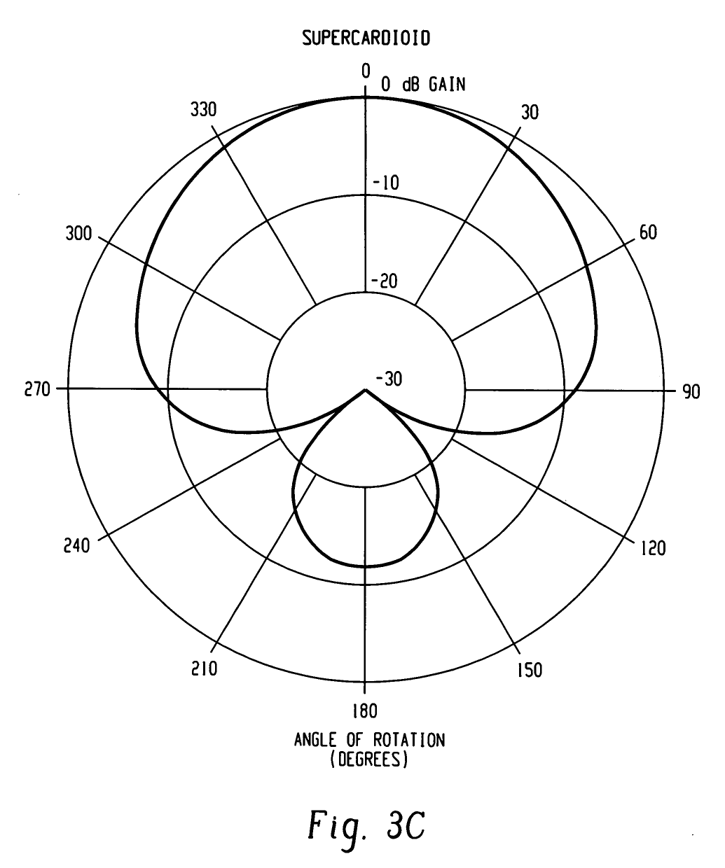

FIG. 2 is a block diagram of an example digital signal processor. The audio signals from the microphones 5, 7 are digitized by analog to digital converters (A/D) 13, processed through a filter bank 14 to optimize the overall frequency response and combined in a manner that can effectively create a desired directional response, such as shown in FIG. 3A-3C. The combined digital audio signal is then transformed back to analog audio by the digital to analog converter (D/A) 15 and output from the digital signal processor 6. With reference again to FIG. 1, the analog output of the digital signal processor 6 is converted into a digital audio signal by the audio CODEC 3. The digital audio output from the audio CODEC 3 is then converted to an RF signal by the radio 2, and is transmitted to the mobile communication device by the antenna 1.

By integrating a signal processor 6 and microphones 5, 7 into the communication headset, a directional response can be generated that eliminates the need for a mechanical boom extending out from the headset. This may be achieved by focusing the voice field pickup and also by eliminating the ambient noise environment. The elimination of the mechanical boom allows the headset to be made smaller and more comfortable for the user, and also less obtrusive. Moreover, because the signal processor 6 is programmable, it can generate a number of different directionality responses and thus can be tailored for a particular user or a particular environment. For example, the control input to the digital signal processor 6 may be used to select from different possible directionality responses, such as the directional responses illustrated in FIGS. 3A-3C.

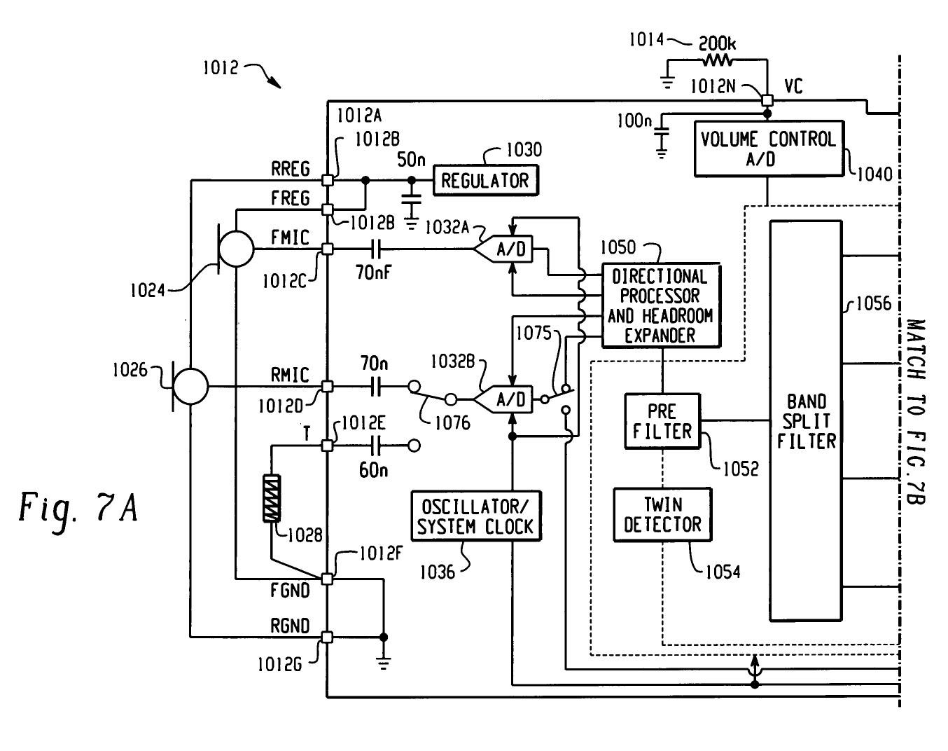

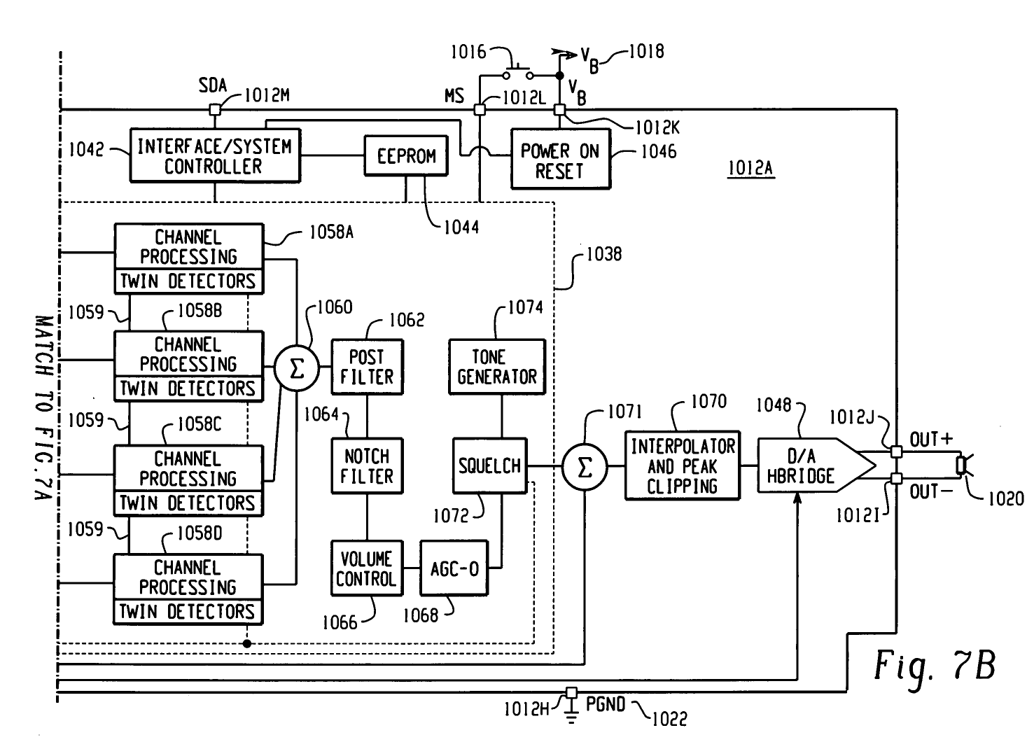

In addition, the signal processor 6 may enable the headset to operate in a second mode as a programmable digital hearing aid device. An example digital hearing aid system is described below with reference to FIGS. 7A and 7B. In a dual-mode wireless headset, the processing functions of the digital hearing aid system of FIGS. 7A and 7B may, for example, be implemented with the headset signal processor(s). Additional hearing instrument processing functions which may be implemented in a dual-mode wireless headset, including further details regarding the directional processing capability of the device, are described in commonly owned U.S. patent application Ser. No. 10/383,141, which is incorporated herein by reference. It should be understood that other digital hearing instrument systems and functions could also be implemented in the communication headset. In addition, the digital processing functions may also be used for a user without a hearing impairment. For instance, the processing functions the digital signal processor may be used to compensate for the changes in acoustics that result from positioning a headset earpiece into the ear canal.

By integrating hearing instrument processing functions into the headset described herein, a multi-mode communication device is provided. This multi-mode communication device can be used in a first mode in which the directionality of the microphones are configured for picking up the speech of the user, and in a second mode in which the directionality of the microphones are configured to hear the speech of a nearby person to whom the user is communicating. For example, in the first mode, the headset may communicate with another communication device, such as a cell phone, and in the second mode the headset may be used as a digital hearing aid.

The control input to the digital signal processor 6 may, for example, be used to switch between different headset modes (e.g., communication mode and hearing instrument mode). In addition, the control input may be used for other configuration purposes, such as programming the hearing instrument settings, turning the headset on and off, setting up the conditions of directionality, or others. The control input may, for example, be received wirelessly via the radio 2, or may be received through a direct connection to the headset or via one or more user input devices on the headset (e.g., a button, a toggle switch, a trimmer, etc.)

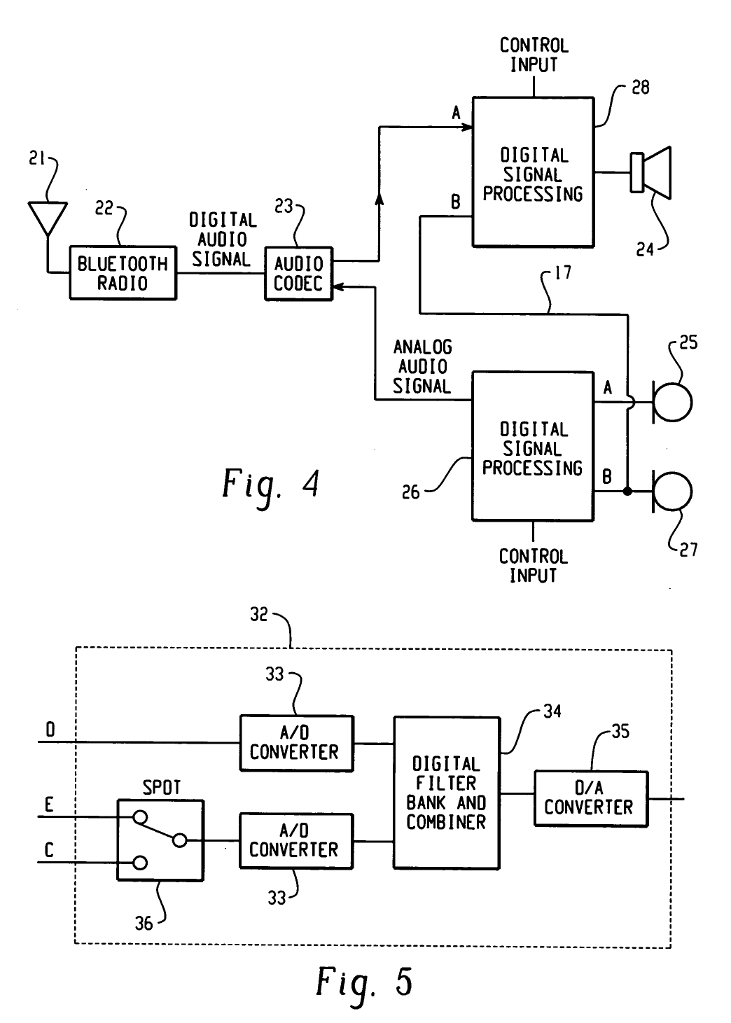

FIG. 4 is a block diagram of an example communication headset having signal processing capabilities in which a pair of signal processors 26, 28 are provided. In this example, a second digital signal processing block 28 is provided in the receiver (i.e., speaker) path between an audio CODEC 23 and a speaker 24. The analog audio output from the audio CODEC 23 is connected to input A of the signal processor 28, where it is digitized and processed to correct impairments in the overall frequency response. Input B of the signal processor 28 is connected 17 to one 27 of a pair of headset microphones 25, 27.

In one example, the headset microphone 27 connected to Input B of the signal processor 28 may be an inner-ear microphone. That is, the microphone 27 may be positioned to receive acoustical signals from within the ear canal of a user of the headset. The acoustical signals received from the inner-ear microphone 27 may, for example, be used by the signal processor 28 to reduce occlusion, particularly when the headset is operating in a hearing instrument mode. As described below, occlusion may occur when the headset is inserted into a users ear canal, resulting in hearing impairment because of the plugged ear. For some individuals, this is disorienting and uncomfortable, especially if the headset must be worn for long periods of time. In order to reduce occlusion, the acoustical signal received by the inner-ear microphone 27 may be subtracted from the acoustical signal being transmitted into the user's ear canal by the speaker 24. One example processing system for reducing occlusion is described below with reference to FIGS. 7A and 7B.

In another example, the occlusion effect may be reduced by providing a sample of environmental sounds to the user's ear. In this example, the microphone 27 connected to Input B of the processor 28 may be one of a pair of external microphones. Environmental sounds (i.e., acoustical signals from outside of the ear canal) may be received by the microphone 27 and introduced by the signal processor 28 into the acoustical signal being transmitted into the ear canal in order to reduce occlusion. By electronic (e.g., a control signal sent by a wireless or direct link) or manual means via the control input to the digital signal processor 28, the user may turn down or turn off the environmental sounds, for example when the headset is in a communication mode (e.g., when a cellular call is initiated or in progress.)

In other examples, the signal processor 26 in the microphone path may perform a first set of signal processing functions and the signal processor 28 in the receiver path may perform a second set of signal processing functions. For instance, processing functions more specific to hearing correction, such as occlusion cancellation and hearing impairment correction, may be performed by the signal processor 28 in the receiver path. Other signal processing functions, such as directional processing and noise cancellation, may be performed by the signal processor 26 in the microphone path. In this manner, while the headset is in a communication mode (e.g., operating as a wireless headset for a cellular telephone communication) one signal processor 26 may be dedicated to outgoing signals and the other signal processor 28 may be dedicated to incoming signals. For instance, a first signal processor 26 may be used in the communication mode to process the acoustical signals received by the microphones 25, 27 to control the microphone directionality such that the voice of the headset user is prominent in the acoustical signal, and to filter out environmental noises from the signal. A second signal processor 28 may, for example, be used in the communication mode to process the received signal to correct for hearing impairments of the user.

It should be understood that although shown as two separate processing blocks in FIG. 4, the digital signal processors 26, 28 may be implemented using a single device.

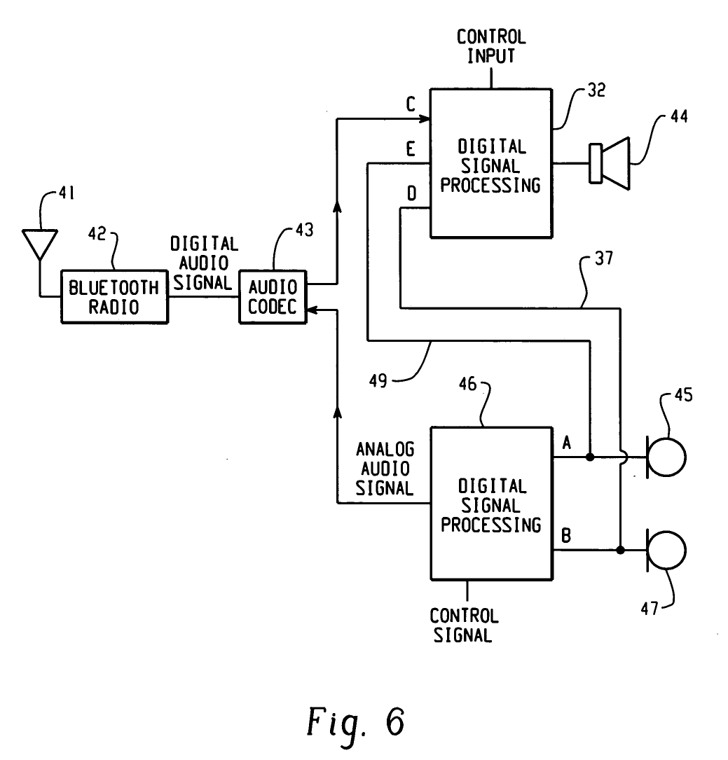

FIG. 5 is a block diagram of another example digital signal processor 32. FIG. 6 is a block diagram of an example communication headset incorporating the digital signal processor 32 of FIG. 5. In this example, a single-pole double-throw (SPDT) switch 36 is added to the signal processing block 32. Inputs C and E to the digital signal processing block 32 are connected to the poles of the switch 36. The audio signal from an audio CODEC 43 is connected to input C and a microphone 45 is connected to input E of the signal processing block 32.

The switch 36 may, for example, be used to enable directional processing in the digital signal processor 32. For example, if input E to the switch 36 is selected, then both microphone signals 45, 47 are available to the signal processor 36, allowing various directional responses to be formed for the benefit of the user. In addition, the switch 36 may be used to toggle the headset between a communication mode (e.g., a cellular telephone mode) and a hearing instrument mode. For instance, when the headset is in communication mode, the switch 36 may connect audio signals (C) received from radio communications circuitry 42 (e.g., incoming cellular signals) to the signal processor 32, and may also connect omni-directional audio signals (D) from one of the microphones 47. When the headset is in hearing instrument mode, the switch 36 may, for example, connect audio signals (D and E) from both microphones 45, 47 to generate a bi-directional audio signal. In one example, the signal processor 32 may receive a control signal from an external device (e.g., a cellular telephone) via the radio communications circuitry 42 to automatically switch the headset between hearing instrument mode and communication mode, for instance when an incoming cellular call is received.

FIGS. 7A and 7B are a block diagram of an example digital hearing aid system 1012 that may be used in a communication headset as described herein. The digital hearing aid system 1012 includes several external components 1014, 1016, 1018, 1020, 1022, 1024, 1026, 1028, and, preferably, a single integrated circuit (IC) 1012A. The external components include a pair of microphones 1024, 1026, a tele-coil 1028, a volume control potentiometer 1024, a memory-select toggle switch 1016, battery terminals 1018, 1022, and a speaker 1020.

Sound is received by the pair of microphones 1024, 1026, and converted into electrical signals that are coupled to the FMIC 1012C and RMIC 1012D inputs to the IC 1012A. FMIC refers to “front microphone,” and RMIC refers to “rear microphone.” The microphones 1024, 1026 are biased between a regulated voltage output from the RREG and FREG pins 1012B, and the ground nodes FGND 1012F, RGND 1012G. The regulated voltage output on FREG and RREG is generated internally to the IC 1012A by regulator 1030.

The tele-coil 1028 is a device used in a hearing aid that magnetically couples to a telephone handset and produces an input current that is proportional to the telephone signal. This input current from the tele-coil 1028 is coupled into the rear microphone A/D converter 1032B on the IC 1012A when the switch 1076 is connected to the “T” input pin 1012E, indicating that the user of the hearing aid is talking on a telephone. The tele-coil 1028 is used to prevent acoustic feedback into the system when talking on the telephone.

The volume control potentiometer 1014 is coupled to the volume control input 1012N of the IC. This variable resistor is used to set the volume sensitivity of the digital hearing aid.

The memory-select toggle switch 1016 is coupled between the positive voltage supply VB 1018 to the IC 1012A and the memory-select input pin 1012L. This switch 1016 is used to toggle the digital hearing aid system 1012 between a series of setup configurations. For example, the device may have been previously programmed for a variety of environmental settings, such as quiet listening, listening to music, a noisy setting, etc. For each of these settings, the system parameters of the IC 1012A may have been optimally configured for the particular user. By repeatedly pressing the toggle switch 1016, the user may then toggle through the various configurations stored in the read-only memory 1044 of the IC 1012A.

The battery terminals 1012K, 1012H of the IC 1012A are preferably coupled to a single 1.3 volt zinc-air battery. This battery provides the primary power source for the digital hearing aid system.

The last external component is the speaker 1020. This element is coupled to the differential outputs at pins 1012J, 1012I of the IC 1012A, and converts the processed digital input signals from the two microphones 1024, 1026 into an audible signal for the user of the digital hearing aid system 1012.

There are many circuit blocks within the IC 1012A. Primary sound processing within the system is carried out by the sound processor 1038. A pair of A/D converters 1032A, 1032B are coupled between the front and rear microphones 1024, 1026, and the sound processor 1038, and convert the analog input signals into the digital domain for digital processing by the sound processor 1038. A single D/A converter 1048 converts the processed digital signals back into the analog domain for output by the speaker 1020. Other system elements include a regulator 1030, a volume control A/D 1040, an interface/system controller 1042, an EEPROM memory 1044, a power-on reset circuit 1046, and a oscillator/system clock 1036.

The sound processor 1038 preferably includes a directional processor and headroom expander 1050, a pre-filter 1052, a wide-band twin detector 1054, a band-split filter 1056, a plurality of narrow-band channel processing and twin detectors 1058A-1058D, a summer 1060, a post filter 1062, a notch filter 1064, a volume control circuit 1066, an automatic gain control output circuit 1068, a peak clipping circuit 1070, a squelch circuit 1072, and a tone generator 1074.

Operationally, the sound processor 1038 processes digital sound as follows. Sound signals input to the front and rear microphones 1024, 1026 are coupled to the front and rear A/D converters 1032A, 1032B, which are preferably Sigma-Delta modulators followed by decimation filters that convert the analog sound inputs from the two microphones into a digital equivalent. Note that when a user of the digital hearing aid system is talking on the telephone, the rear A/D converter 1032B is coupled to the tele-coil input “T” 1012E via switch 1076. Both of the front and rear A/D converters 1032A, 1032B are clocked with the output clock signal from the oscillator/system clock 1036. This same output clock signal is also coupled to the sound processor 1038 and the D/A converter 1048.

The front and rear digital sound signals from the two A/D converters 1032A, 1032B are coupled to the directional processor and headroom expander 1050 of the sound processor 1038. The rear A/D converter 1032B is coupled to the processor 1050 through switch 1075. In a first position, the switch 1075 couples the digital output of the rear A/D converter 1032 B to the processor 1050, and in a second position, the switch 1075 couples the digital output of the rear A/D converter 1032B to summation block 1071 for the purpose of compensating for occlusion.

Occlusion is the amplification of the users own voice within the ear canal. The rear microphone can be moved inside the ear canal to receive this unwanted signal created by the occlusion effect. The occlusion effect is usually reduced in these types of systems by putting a mechanical vent in the hearing aid. This vent, however, can cause an oscillation problem as the speaker signal feeds back to the microphone(s) through the vent aperture. Another problem associated with traditional venting is a reduced low frequency response (leading to reduced sound quality). Yet another limitation occurs when the direct coupling of ambient sounds results in poor directional performance, particularly in the low frequencies. The hearing instrument system shown in FIGS. 7A and 7B solves these problems by canceling the unwanted signal received by the rear microphone 1026 by feeding back the rear signal from the A/D converter 1032B to summation circuit 1071. The summation circuit 1071 then subtracts the unwanted signal from the processed composite signal to thereby compensate for the occlusion effect.

The directional processor and headroom expander 1050 includes a combination of filtering and delay elements that, when applied to the two digital input signals, forms a single, directionally-sensitive response. This directionally-sensitive response is generated such that the gain of the directional processor 1050 will be a maximum value for sounds coming from the front microphone 1024 and will be a minimum value for sounds coming from the rear microphone 1026.

The headroom expander portion of the processor 1050 significantly extends the dynamic range of the A/D conversion, which is very important for high fidelity audio signal processing. It does this by dynamically adjusting the A/D converters 1032A/1032B operating points. The headroom expander 1050 adjusts the gain before and after the A/D conversion so that the total gain remains unchanged, but the intrinsic dynamic range of the A/D converter block 1032A/1032B is optimized to the level of the signal being processed.

The output from the directional processor and headroom expander 1050 is coupled to a pre-filter 1052, which is a general-purpose filter for pre-conditioning the sound signal prior to any further signal processing steps. This “pre-conditioning” can take many forms, and, in combination with corresponding “post-conditioning” in the post filter 1062, can be used to generate special effects that may be suited to only a particular class of users. For example, the pre-filter 1052 could be configured to mimic the transfer function of the user's middle ear, effectively putting the sound signal into the “cochlear domain.” Signal processing algorithms to correct a hearing impairment based on, for example, inner hair cell loss and outer hair cell loss, could be applied by the sound processor 1038. Subsequently, the post-filter 1062 could be configured with the inverse response of the pre-filter 1052 in order to convert the sound signal back into the “acoustic domain” from the “cochlear domain.” Of course, other pre-conditioning/post-conditioning configurations and corresponding signal processing algorithms could be utilized.

The pre-conditioned digital sound signal is then coupled to the band-split filter 1056, which preferably includes a bank of filters with variable corner frequencies and pass-band gains. These filters are used to split the single input signal into four distinct frequency bands. The four output signals from the band-split filter 1056 are preferably in-phase so that when they are summed together in block 1060, after channel processing, nulls or peaks in the composite signal (from the summer) are minimized.

Channel processing of the four distinct frequency bands from the band-split filter 1056 is accomplished by a plurality of channel processing/twin detector blocks 1058A-1058D. Although four blocks are shown in FIGS. 77B, it should be clear that more than four (or less than four) frequency bands could be generated in the band-split filter 1056, and thus more or less than four channel processing/twin detector blocks 1058 may be utilized with the system.

Each of the channel processing/twin detectors 1058A-1058D provide an automatic gain control (“AGC”) function that provides compression and gain on the particular frequency band (channel) being processed. Compression of the channel signals permits quieter sounds to be amplified at a higher gain than louder sounds, for which the gain is compressed. In this manner, the user of the system can hear the full range of sounds since the circuits 1058A-1058D compress the full range of normal hearing into the reduced dynamic range of the individual user as a function of the individual user's hearing loss within the particular frequency band of the channel.

The channel processing blocks 1058A-1058D can be configured to employ a twin detector average detection scheme while compressing the input signals. This twin detection scheme includes both slow and fast attack/release tracking modules that allow for fast response to transients (in the fast tracking module), while preventing annoying pumping of the input signal (in the slow tracking module) that only a fast time constant would produce. The outputs of the fast and slow tracking modules are compared, and the compression slope is then adjusted accordingly. The compression ratio, channel gain, lower and upper thresholds (return to linear point), and the fast and slow time constants (of the fast and slow tracking modules) can be independently programmed and saved in memory 1044 for each of the plurality of channel processing blocks 1058A-1058D.

FIG. 7B also shows a communication bus 1059, which may include one or more connections, for coupling the plurality of channel processing blocks 1058A-1058D. This inter-channel communication bus 1059 can be used to communicate information between the plurality of channel processing blocks 1058A-1058D such that each channel (frequency band) can take into account the “energy” level (or some other measure) from the other channel processing blocks. Preferably, each channel processing block 1058A-1058D would take into account the “energy” level from the higher frequency channels. In addition, the “energy” level from the wide-band detector 1054 may be used by each of the relatively narrow-band channel processing blocks 1058A-1058D when processing their individual input signals.

After channel processing is complete, the four channel signals are summed by summer 1060 to form a composite signal. This composite signal is then coupled to the post-filter 1062, which may apply a post-processing filter function as discussed above. Following post-processing, the composite signal is then applied to a notch-filter 1064, that attenuates a narrow band of frequencies that is adjustable in the frequency range where hearing aids tend to oscillate. This notch filter 1064 is used to reduce feedback and prevent unwanted “whistling” of the device. Preferably, the notch filter 1064 may include a dynamic transfer function that changes the depth of the notch based upon the magnitude of the input signal.

Following the notch filter 1064, the composite signal is then coupled to a volume control circuit 1066. The volume control circuit 1066 receives a digital value from the volume control A/D 1040, which indicates the desired volume level set by the user via potentiometer 1014, and uses this stored digital value to set the gain of an included amplifier circuit.

From the volume control circuit, the composite signal is then coupled to the AGC-output block 1068. The AGC-output circuit 1068 is a high compression ratio, low distortion limiter that is used to prevent pathological signals from causing large scale distorted output signals from the speaker 1020 that could be painful and annoying to the user of the device. The composite signal is coupled from the AGC-output circuit 1068 to a squelch circuit 1072, that performs an expansion on low-level signals below an adjustable threshold. The squelch circuit 1072 uses an output signal from the wide-band detector 1054 for this purpose. The expansion of the low-level signals attenuates noise from the microphones and other circuits when the input S/N ratio is small, thus producing a lower noise signal during quiet situations. Also shown coupled to the squelch circuit 1072 is a tone generator block 1074, which is included for calibration and testing of the system.

The output of the squelch circuit 1072 is coupled to one input of summer 1071. The other input to the summer 1071 is from the output of the rear A/D converter 1032B, when the switch 1075 is in the second position. These two signals are summed in summer 1071, and passed along to the interpolator and peak clipping circuit 1070. This circuit 1070 also operates on pathological signals, but it operates almost instantaneously to large peak signals and is high distortion limiting. The interpolator shifts the signal up in frequency as part of the D/A process and then the signal is clipped so that the distortion products do not alias back into the baseband frequency range.

The output of the interpolator and peak clipping circuit 1070 is coupled from the sound processor 1038 to the D/A H-Bridge 1048. This circuit 1048 converts the digital representation of the input sound signals to a pulse density modulated representation with complimentary outputs. These outputs are coupled off-chip through outputs 1012J, 1012I to the speaker 1020, which low-pass filters the outputs and produces an acoustic analog of the output signals. The D/A H-Bridge 1048 includes an interpolator, a digital Delta-Sigma modulator, and an H-Bridge output stage. The D/A H-Bridge 1048 is also coupled to and receives the clock signal from the oscillator/system clock 1036.

The interface/system controller 1042 is coupled between a serial data interface pin 1012M on the IC 1012, and the sound processor 1038. This interface is used to communicate with an external controller for the purpose of setting the parameters of the system. These parameters can be stored on-chip in the EEPROM 1044. If a “black-out” or “brown-out” condition occurs, then the power-on reset circuit 1046 can be used to signal the interface/system controller 1042 to configure the system into a known state. Such a condition can occur, for example, if the battery fails.

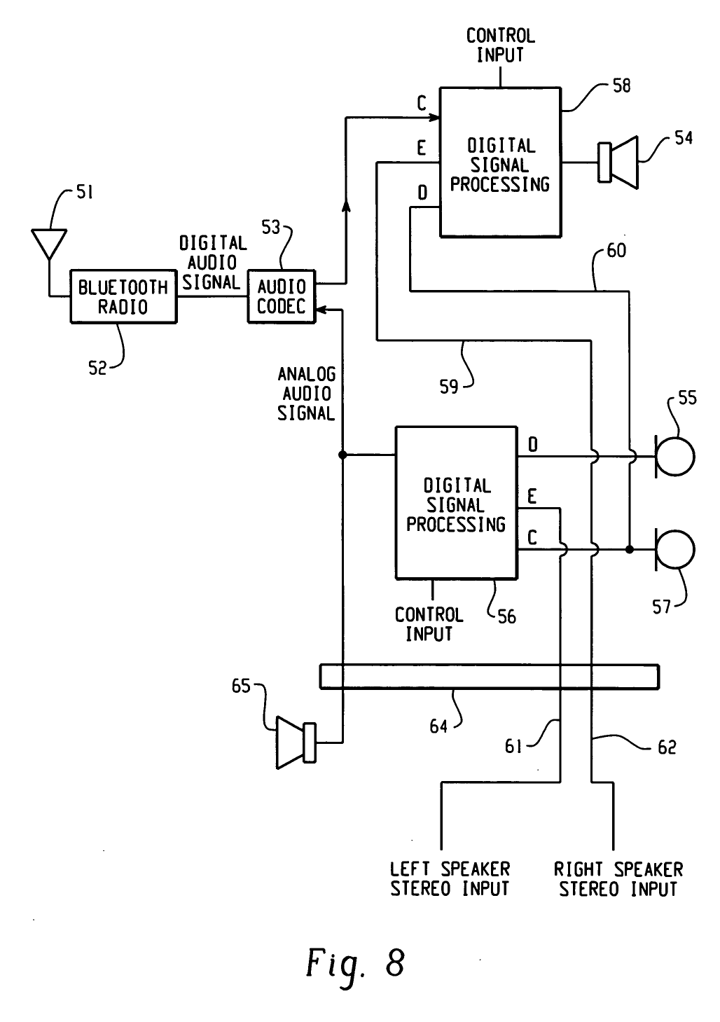

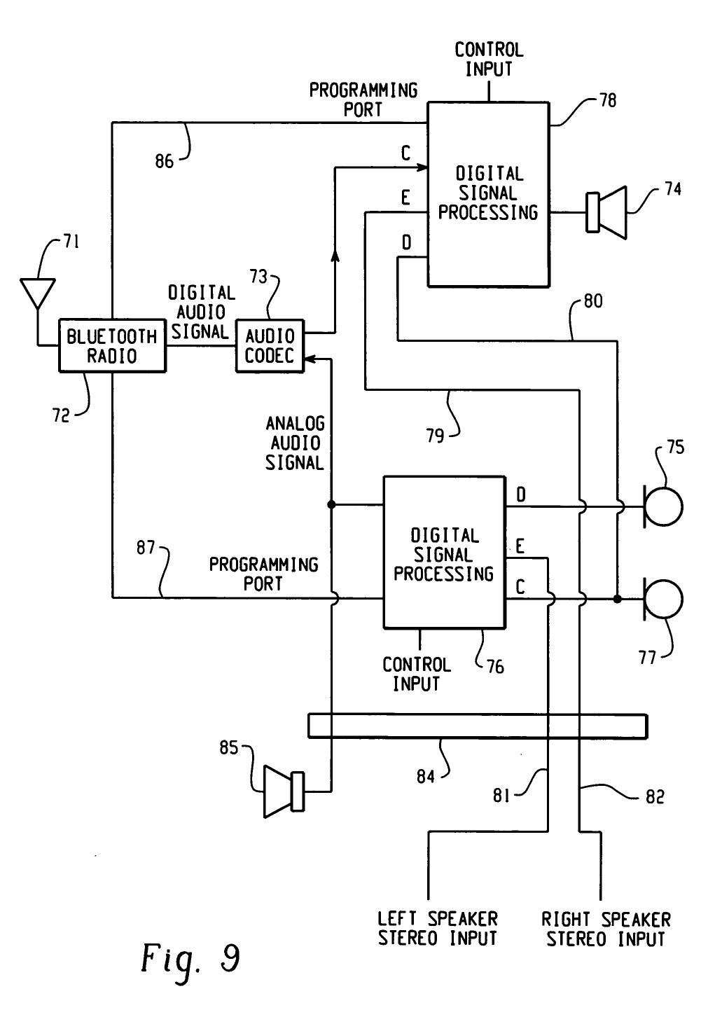

This written description uses examples to disclose the invention, including the best mode, and also to enable a person skilled in the art to make and use the invention. The patentable scope of the invention may include other examples that occur to those skilled in the art. As an example of the wide scope of the communication headset disclosed herein, FIGS. 8 and 9 illustrate example communication headsets having signal processing capabilities and also providing wired and wireless audio processing.

In the example of FIG. 8, the communication headset may be configured to listen to a high fidelity external stereo audio source such as a CD player or MP3 player. In this example, the left and right side audio feeds 61, 62 from an external source are connected to input E on each digital signal processing block 56, 58, respectively, where the audio feeds 61, 62 are processed to provide an optimum audio response. The left side audio output is fed, as shown, through stereo connector 64 to a left speaker 65. The right side audio feed 62 is connected through stereo connector 64 to input E of the other signal processing block 58, processed to optimize the audio response, and then routed to a right speaker 54. When the user wishes to listen to the external stereo audio source, switches in both digital signal processing blocks 56, 58 may be set in position E to receive the stereo audio feed. When a call arrives, the switches in both digital signal processing blocks 56, 58 may be switched to position C, via the control input, in order to turn off the stereo feed and allows the user to answer the call.

FIG. 9 shows another example headset having connections 86 and 87 from a radio communications circuitry 72 to a programming port of the digital signal processing blocks 76, 78. If the headset user is not on a call and the headset is configured in a stereo mode with left and right audio feeds 81, 82, then the digital signal processing blocks 76, 78, as a result of individually adjustable filters (amplitude and bandwidth) within the processors' filter banks, can be made to function as an audio equalizer. That is, the audio characteristics of the left and right audio feeds 81, 82 may be altered by the digital signal processing blocks 76, 78 using pre-programmed equalizer settings, such as amplitude and bandwidth settings. Using these settings, the digital signal processing blocks 76, 78 may divide a given signal bandwidth into a number of bins, wherein each bin may be of equal or different bandwidths. In addition, each bin may be capable of individual amplitude adjustment. An application running on a computer, which emulates a graphical equalizer, can be displayed on a computer screen and adjusted in real time under user control. The equalizer settings may be transferred over the wireless link to the headset, where the amplitude and bandwidth settings for each filter within the filter bank of the signal processors 76, 78 are programmed via the programming ports of digital signal processing blocks 76, 78. It should be understood that other devices may also be used to program the headset equalizer settings, such as an MP3 player or other mobile device in wired or wireless communication with the headset.

1. A dual-mode wireless headset for a communication device, comprising:
radio communications circuitry operable to communicate wirelessly with the communication device;
a speaker for directing acoustical signals into the ear canal of a headset user;
a microphone for receiving acoustical signals; and
a digital signal processor for processing acoustical signals, the digital signal processor being operable in a first mode and a second mode;
when in the first mode, the digital signal processor being operable to process an acoustical signal received by the microphone to control the directionality of the microphone such that the voice of the headset user is prominent in the acoustical signal;
when in the second mode, the digital signal processor being operable to process the acoustical signal received by the microphone to control the directionality of the microphone such that sounds other than the voice of the headset user are prominent in the acoustical signal;
when in the first mode, the digital signal processor being further operable to transmit the processed acoustical signal to the mobile communication device via the radio communications circuitry.

2. The dual-mode wireless headset of claim 1, wherein when in the second mode, the digital signal processor being further operable to process the acoustical signal to compensate for a hearing impairment of the headset user and to transmit the processed acoustical signal into the ear canal of the headset user via the speaker.

3. The dual-mode wireless headset of claim 1, wherein the digital signal processor is further operable when in the first mode to transmit acoustical signals received from the communication device into the ear canal of the headset user via the speaker.

4. The dual-mode wireless headset of claim 3, wherein the digital signal processor is further operable when in the first mode to process the acoustical signals received from the communication device to compensate for the hearing impairment of the headset user.

5. The dual-mode wireless headset of claim 1, wherein the communication device is a cellular telephone.

6. The dual-mode wireless headset of claim 1, further comprising a second microphone for receiving acoustical signals.

7. The dual-mode wireless headset of claim 6, wherein the digital signal processor when in the first mode processes the acoustical signals received from the microphone and from the second microphone to control the directionality of the microphone and the second microphone such that the voice of the headset user is prominent in the acoustical signal.

8. The dual-mode wireless headset of claim 1, wherein the digital signal processor is operable to receive an input that is used to determine the directionality of the microphone.

9. The dual-mode wireless headset of claim 8, wherein the input for determining the directionality of the microphone is received wirelessly from the communication device.

10. The dual-mode wireless headset of claim 8, wherein the input is selected from a plurality of possible directional responses.

11. The dual-mode wireless headset of claim 8, wherein the input for determining the directionality of the microphone is received from a user input device on the headset.

12. The dual-mode wireless headset of claim 1, wherein the digital signal processor includes a first processor and a second processor, the first processor being operable to control the directionality of the microphone and the second processor being operable to compensate for the hearing impairment of the headset user.

13. The dual-mode wireless headset of claim 12, wherein the first and second processors are implemented by a single processing device.

14. The dual-mode wireless headset of claim 1, wherein the digital signal processor is further operable to process acoustical signals to be transmitted into the ear canal of the headset user to reduce an occlusion effect perceived by the headset user.

15. A dual-mode wireless headset for a communication device, comprising:
radio communications circuitry operable to communicate wirelessly with the communication device;
a speaker for directing acoustical signals into the ear canal of a headset user;
a microphone for receiving acoustical signals; and
a digital signal processor for processing acoustical signals, the digital signal processor being operable in a communication mode and a hearing instrument mode;
when in the communication mode, the digital signal processor being operable to communicate wirelessly with the communication device to transmit acoustical signals received by the microphone to the communication device and to transmit acoustical signals received from the communication device into the ear canal of the headset user via the speaker;
when in the hearing instrument mode, the digital signal processor being operable to process acoustical signals received by the microphone to compensate for a hearing impairment of the headset user and to transmit the processed acoustical signals into the ear canal of the headset user via the speaker;
the digital signal processor being further operable to process acoustical signals to be transmitted into the ear canal of the headset user to reduce an occlusion effect perceived by the headset user.

16. The dual-mode wireless headset of claim 15, wherein the digital signal processor reduces the occlusion effect by including environmental sounds received by the microphone in the acoustical signals transmitted into the ear canal of the headset user via the speaker.

17. The dual-mode wireless headset of claim 15, further comprising:
a inner-ear microphone for receiving acoustical signals from within the ear canal of the headset user;
wherein the digital signal processor reduces the occlusion effect by subtracting the acoustical signals received by the inner-ear microphone from the processed acoustical signals transmitted into the ear canal of the headset user via the speaker.

18. The dual-mode wireless headset of claim 15, wherein the digital signal processor is further operable when in the communication mode to transmit acoustical signals received from the communication device into the ear canal of the headset user via the speaker.

19. The dual-mode wireless headset of claim 18, wherein the digital signal processor is further operable when in the communication mode to process the acoustical signals received from the communication device to compensate for the hearing impairment of the headset user.

20. The dual-mode wireless headset of claim 15, wherein the communication device is a cellular telephone.

21. The dual-mode wireless headset of claim 15, further comprising a second microphone for receiving acoustical signals.

22. The dual-mode wireless headset of claim 15, wherein the functions of the digital signal processor are performed by a first processor and a second processor.

23. The dual-mode wireless headset of claim 22, wherein the first processor and the second processor are implemented by a single processing device.

24. A dual-mode wireless headset, comprising:
radio communications circuitry operable to communicate wirelessly with an external device;
a speaker for directing acoustical signals into the ear canal of a headset user;
a microphone for receiving acoustical signals; and
a digital signal processor for processing acoustical signals, the digital signal processor being operable in a first mode and a second mode;
when in the first mode, the digital signal processor being operable to wirelessly receive a first acoustical signal from the external device via the radio communications circuitry, process the first acoustical signal to alter the audio characteristics of the first acoustical signal using pre-programmed amplitude and bandwidth settings and transmit the processed first acoustical signal into the ear canal of the headset user via the speaker;
when in the second mode, the digital signal processor being operable to receive a second acoustical signal from the microphone, process the second acoustical signal to compensate for a hearing impairment of the headset user and transmit the processed second acoustical signal into the ear canal of the headset user via the speaker;
the digital signal processor being further operable to wirelessly receive an equalizer setting via the radio communications circuitry and use the equalizer setting to program the amplitude and bandwidth settings.

25. The dual-mode wireless headset of claim 24, wherein the digital signal processor is further operable in the first mode to process the first acoustical signal to compensate for the hearing impairment of the headset user.

26. The dual-mode wireless headset of claim 24, wherein the external device is a radio.

27. The dual-mode wireless headset of claim 24, wherein the external device is a MP3 player.

28. The dual-mode wireless headset of claim 24, wherein the external device is a CD player.

29. The dual-mode wireless headset of claim 24, wherein the external device is a game machine.

30. The dual-mode wireless headset of claim 24, wherein the external device is a cellular telephone.

31. The dual-mode wireless headset of claim 24, wherein the external device is a computer.

32. The dual-mode wireless headset of claim 24, further comprising a second microphone for receiving acoustical signals.

33. The dual-mode wireless headset of claim 24, wherein the equalizer setting is received from the external device.

34. The dual-mode wireless headset of claim 24, wherein the equalizer setting is received from a second external device.

35. The dual-mode wireless headset of claim 34, wherein the second external device is a computer.

36. The dual-mode wireless headset of claim 34, wherein the second external device is a remote control.
